(19) United States
(12) Patent Application Publication
(10) Pub. No.: US 2004/0160115 A1
(43) Pub. Date: Aug. 19, 2004

(54) Hub cap having an air valve for bearing cavity pressurization

(76) Inventor: M. Sid Allsop, Orem, UT (US)

Correspondence Address: Angus C. Fox, III, 4093 N. Imperial Way, Provo, UT, 84604-5386, US

(21) Appl. No.: 10/366,969

(22) Filed: Feb. 13, 2003

(51) Int. Cl. B60B 27/00

(52) U.S. Cl. 301/108.1

(57) ABSTRACT

A hub cap is provided for boat trailer wheel hubs that includes an air valve. The valve may take several different forms. A first embodiment hub cap employs a needle valve that is inserted through an aperture formed within the hub cap body. A second embodiment hub cap employs a Schrader-type valve. The valved hub cap allows the hub cavity to be temporarily pressurized when a boat trailer is partially submerged during the launch and recovery of a boat. Additional features may be incorporated in the hub cap, including a pressure release valve, which prevents damage to the hub seal, an O-ring groove in the hub cap body, which seals the cap to the hub and may also secure the hub cap to the wheel hub body. A separate spring retainer clip is also provided, which secures the hub cap to the hub body.

### BACKGROUND OF THE INVENTION

1. Field of the Invention

This invention relates to hub caps for wheel hubs having tapered roller bearing races within a sealed cavity and, more particularly, to hub caps having an air valve through which the sealed cavity can be pressurized to prevent the inflow of water when the wheel hub is submerged in water, as when hubs on a boat trailer are submerged in the water during launching and recovery of the boat.

2. Description of the Prior Art

Referring now to FIG. 1, a conventional boat trailer wheel hub 100 typically has inner and outer tapered roller bearing assemblies 101A and 101B, respectively. Each bearing assembly has an inner race 102 that is mounted on the axle 103, an outer race 104 that is pressed into the hub body 105, and a plurality of tapered rollers 106 mounted in an annular roller retainer 107, which ride against both the inner and outer races. As the races and tapered rollers are fabricated from hardened steel, they are extremely vulnerable to corrosion. Wheel hubs typically have a cavity 108, which is spanned by the axle shaft between the inner and outer bearing assemblies, and open at both ends. The cavity is filled with a high-temperature grease (not shown) in sufficient quantity that the bearing races and rollers are continually bathed in liquified grease as centrifugal force throws the grease against the cavity walls. The grease is retained within the cavity 108 by a hub cap 109, that is pressed into the nose 110 of the hub body 105 and seals the outer opening, and by a flexible, neoprene rubber seal 111, that seals the inner opening. The neoprene rubber seal 111 is molded into a metal retainer ring 112 that is pressed into the inner opening of the hub. A flexible annular lip (not shown) on the neoprene rubber seal 111 rides against a cylindrical sealing surface on the axle shaft.

Though entirely adequate to protect the bearing assemblies from rain, the neoprene seal is unable to provide hermetic sealing when the hub assembly is submerged. Boat trailer wheel hubs are usually submerged in water during each launching and each recovery of the carried boat. Entry of water into the hub cavity occurs via the following mechanism. When the trailer is being towed, friction caused by a combination of continuing movement of the bearing assemblies, contact of the tires with the road and—if the trailer is so equipped—braking generates heat, which causes the air and grease inside the hub cavity to expand. When the hot hub is submerged in water during launching of the boat, the hub cools and the air and grease inside the hub cavity contract, thereby reducing the pressure within the hub cavity below ambient atmospheric pressure. The neoprene rubber seal, which seals most effectively when the pressure within the hub cavity is greater than ambient atmospheric pressure, actually functions as a one-way valve when the pressure gradient is reversed. Water, sand, and other contaminants flow into the hub cavity until the pressure within the hub is equal to the ambient atmospheric pressure. Once water has found its way into the hub cavity, destruction of the bearing assemblies and possibly the axle shaft via corrosion is inevitable.

The problem of bearing corrosion in boat trailer hubs has spawned a multitude of inventions aimed preventing water from entering into the hub cavitys of trailer wheels. Some of the preventative measures covered by these inventions are costly to implement, others are complex, others are costly, and some are ineffective. The following patents are exemplary of the prior art.

In U.S. Pat. No. 3,785,706, issued to Vangalis on Jan. 15, 1974, there is disclosed a pressurized hub cap for a vehicle wheel. The Vangalis patent describes a cup-shaped cap having a flange which seats on the wheel hub. A helical spring urges a piston in the direction of the axle of the trailer to hold grease on the outside of the axle and associated nut. A vent hole is provided on the outside of the piston, and a second hole is provided to allow the escape of grease in the event that excessive expansion of the grease occurs. A similar construction is described in U.S. Pat. No. 4,106,816, issued to August on Aug. 15, 1978. In U.S. Pat. No. 3,955,852, issued to De Puydt et al. on May 11, 1976, there is also described a trailer hubcap device utilizing a spring-biased piston to pressurize grease against the outside of the axle and nut. The De Puydt et al. patent further describes a manual actuator to permit the pressure to be relieved while the trailer is being moved along a roadway.

A related hubcap construction is described in U.S. Pat. No. 3,649,080, issued to Molinare on Mar. 14, 1972. This patent describes a hubcab construction which includes a grease fitting to permit introduction of grease into the cap and also a pressure relief valve to provide for expansion of the grease. In U.S. Pat. No. 3,393,015, issued to Kaufman of Jul. 16, 1968, there is described a hubcap which includes an O-ring normally positioned over a vent hole to prevent the entrance of water within the cap, but which will expand to uncover the hole for permitting air and grease to be vented from the hubcap when heated. A protective hubcap closure is described in U.S. Pat. No. 3,149,883, issued to Reilly on Sep. 22, 1964. The Reilly patent describes a hubcap which is flexible to become contracted or compressed when the trailer is immersed in cold water.

A different approach to the waterproofing for a hubcap is described in the Eberle patent, U.S. Pat. No. 3,226,162, issued on Dec. 28, 1965. The Eberle patent describes the use of a tube connecting from the pressurized tire to the hubcap, for permitting air to be vented into the hubcap as a method for pressurizing the cap to prevent entrance of water.

Several types of pressure relief hub caps have been produced in the past. One type is shown in U.S. Pat. No. 3,785,706 to Van Galis. In this device, a cup shaped seal is mounted within a cup shaped hub cap, with a spring acting on the seal to compress the grease within the hub. A first opening in the cap adjacent the outer end provides for pressure relief in the spring area between the seal and the outer end of the hub cap. A second opening in the hub cap inboard from the first opening provides for escape of grease when the pressure within the hub is sufficient to compress the spring.

Another type of hub cap is shown in U.S. Pat. No. 3,077,948 to Law. This structure utilizes a cup shaped seal sliding in a sleeve with a spring urging the seal inward to compress the grease. The sealing action occurs between the cup shaped seal and an O-ring in the inner surface of the sleeve. A grease fitting is carried in the sliding seal for introducing grease into the hub.

The hub cap of the U.S. Pat. No. 3,785,706 patent suffers from the disadvantage that grease can be added to the hub only by removing the hub cap. This problem is solved by the hub cap of the U.S. Pat. No. 3,077,948 patent. However there are still some disadvantages with this structure. When the hub is being filled with grease by a grease gun, the manual force utilized in holding the grease gun in place also acts to hold the sliding seal in fixed position so that excess pressure can be built up within the hub and the inner bearing seal can be damaged without the operator knowing of this fact. That is, the automatic pressure release operation is nullified by the force applied with the grease gun. Also, the cup shaped seal which slides within the outer sleeve or housing and engages the O-ring for making a seal provides only limited area for escape of grease.

One of the more popular devices for affording protection to the bearings of trailer wheels is covered by U.S. Pat. No. 4,106,816 to August. Known as the “Bearing Buddy”, the device is a specially designed hub cap having a sliding piston with a centrally-positioned grease fitting. The piston is biased with a coil spring and is designed to maintain the bearing bathed in grease. One of the problems with this device is that it is impossible to remove all of the air from the cavity by injecting grease from the outer end of the hub, as the inward hub seal will prevent the escape of pressurized air that builds up as grease is injected into the bearing cavity. Because the trapped air and grease have different rates of expansion, it is difficult for the device to work as intended. Another problem is that the spring constantly pressurizes the bearing cavity of the wheel hub. This added pressure forces the wiping portion of the inner neoprene seal more firmly against the outer surface of the axle shaft. The added pressure increases the wear rate of the seal.

Accordingly, it is an object of the present invention to provide a new and improved hub cap that is both simple to use and inexpensive to manufacture, for sealing against the entrance of moisture into the bearing cavity. It is the intent of the present invention to prevent water and other contaminants from entering a boat trailer wheel hub by providing temporary pressurization of the wheel hub cavity at times when the boat trailer must be partially submerged during the launch and recovery of a boat.

### SUMMARY OF THE INVENTION

The present invention provides a hub cap for wheel hubs that includes an air valve. The valve may take several different forms. A first embodiment hub cap employs a needle valve that is inserted through an aperture formed within the hub cap body. An advantage of such a valve is that it is low profile and unlikely to be damaged by towing the trailer too close to stationary objects. A second embodiment hub cap employs a Schrader-type valve that is inserted through an aperture formed within the hub cap body. Each of these valves allows the hub cavity to be temporarily pressurized when a boat trailer is partially submerged during the launch and recovery of a boat. It is intended that the hub cavity pre pressurized only during periods when the wheel hub is submerged, as traveling extended distances with the additional pressure will increase the temperature and wear of the neoprene seal that prevents the escape of grease between the hub and axle at the inner opening of the bearing cavity. Sufficient air pressure is added to the wheel bearing cavity so that it remains above the sum of ambient atmospheric pressure plus the added pressure caused by the depth of submersion, even when a hot hub assembly is submerged in water and the inner pressure is reduced as the hub cools to the temperature of the water.

One of the problems associated with pressurizing the hub cavity is the possibility that the hub cap will be blown off the hub. When hub caps are new, a near perfect interference fit exists between the nose of the wheel hub and the cap. Given the presence of grease, an air tight seal is provided. However, with age and repeated removals of the hub cap, the sealability decreases. Therefore, another aspect of the present invention is the provision of a retainer clip that can be installed over the hub cap and clip into grooves which are cut in the nose of the wheel hub. A boat trailer owner, exercising a reasonable amount of care, can cut the grooves in the wheel hub with a cut-off wheel on a hand grinder tool.

An alternative retaining device for the pressurized hub caps is a ramped annular groove stamped in the hub cap in the portion that is inserted in the nose of the wheel hub. An O-ring is installed within the ramped groove. Given the direction and shape of the ramp, the hub cap can be easily inserted into the wheel hub. However, removal of the cap causes the O-ring to slide up the ramp, forcing it against both the groove and the inner surface of the nose of the wheel hub and preventing the hub cap from being easily removed.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof. In the drawings:

FIG. 1 is a cut-away perspective view of a trailer hub and axle assembly, complete with two sets of installed bearing assemblies and a conventional hub cap shown as ready for attachment thereto;

FIG. 2 is an isometric view of a first embodiment valved hub cap, which has a needle valve installed therein for injecting air into the bearing and axle cavity of a wheel hub;

FIG. 3 is a cross-sectional view of the first embodiment valved hub cap, taken through the needle valve and axis of rotation of the hub cap;

FIG. 4 is an isometric view of a second embodiment valved hub cap, which has a Schrader-type valve stem installed therein;

FIG. 5 is a cross-sectional view of the second embodiment valved hub cap, taken through the central axis of the valve and the axis of rotation of the hub cap;

FIG. 6 is a top planar view of a hub cap retainer clip;

FIG. 7 is a bottom planar view of the hub cap retainer clip of FIG. 6;

FIG. 8 is a side elevational view of the hub cap retainer clip of FIGS. 6 and 7;

FIG. 9 is a modified second embodiment valved hub cap which also incorporates both a pressure release valve and an O-ring groove in which an O-ring has been installed;

FIG. 10 is an enlarged view of region F10 of FIG. 9, showing the detail of a retaining groove having a ramped cross section.

FIG. 11 is an enlarged view showing an O-ring installed in an O-ring groove of conventional cross section;

FIG. 12 is a side elevational view of the external portion of a wheel hub, modified in accordance with the present invention and having a first embodiment valved hub cap installed therein, that is secured to the wheel hub with the retainer clip of FIGS. 6, 7 and 8;

FIG. 13 is an alternative embodiment of a hub cap retainer device shown ready for attachment to a hub having a hub cap installed therein; and

FIG. 14 is a wheel hub that has been modified to include a Schrader-type valve in the hub body.

### DESCRIPTION OF THE PREFERRED EMBODIMENT

The various embodiments of the invention will now be described with reference to the accompanying drawing figures. It should be understood that the drawings are merely illustrative of the invention, are not intended to limit the scope thereof, and are not necessarily drawn to scale.

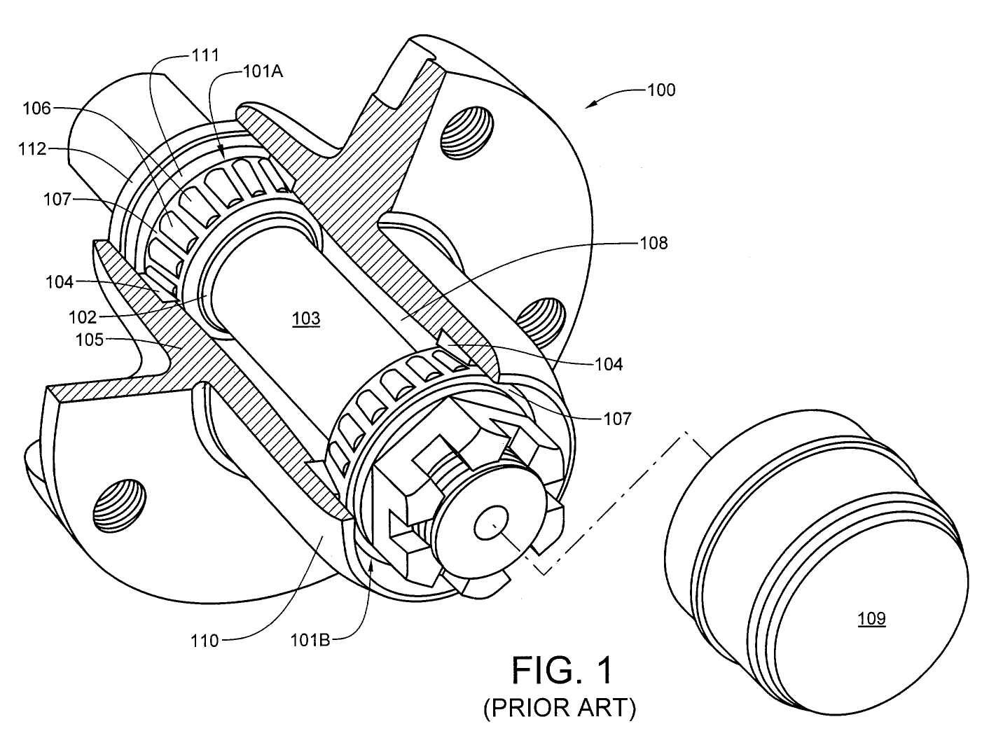

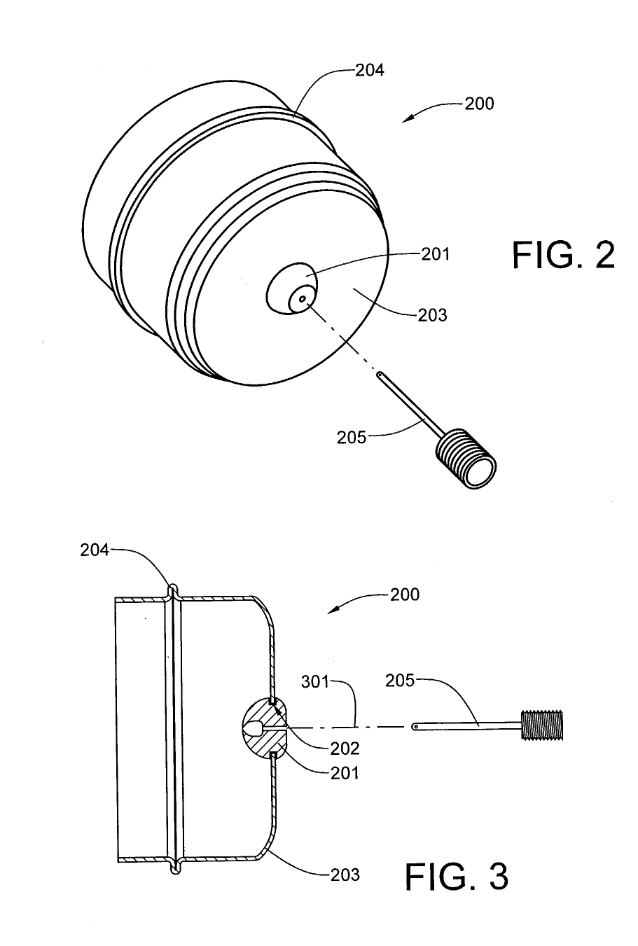

Referring now to FIG. 2, a first embodiment hub cap 200 employs a needle valve 201 that is inserted through an aperture 202 formed within the hub cap body 203. An annular flange 204 limits the amount that the hub cap 200 may be inserted into the nose of the wheel hub. An inflating needle 205, identical to those used to inflate balls and other sports equipment, is shown positioned in an axial relationship with the hub cap. The cap is designed to replace a standard hub cap of the type shown in FIG. 1. An advantage of the needle valve 201 is that it has a low profile that minimizes the potential for damage caused by by towing the trailer too close to stationary objects.

Referring now to the cross-sectional view of FIG. 3, the construction of the needle valve 201 is shown in greater detail. The needle valve 201, which is radially symmetrical about a needle insertion axis 301, is designed so that as air pressure is increased on the inside of the hub cap with respect to ambient air pressure on the outside of the hub cap, the valve seals more tightly.

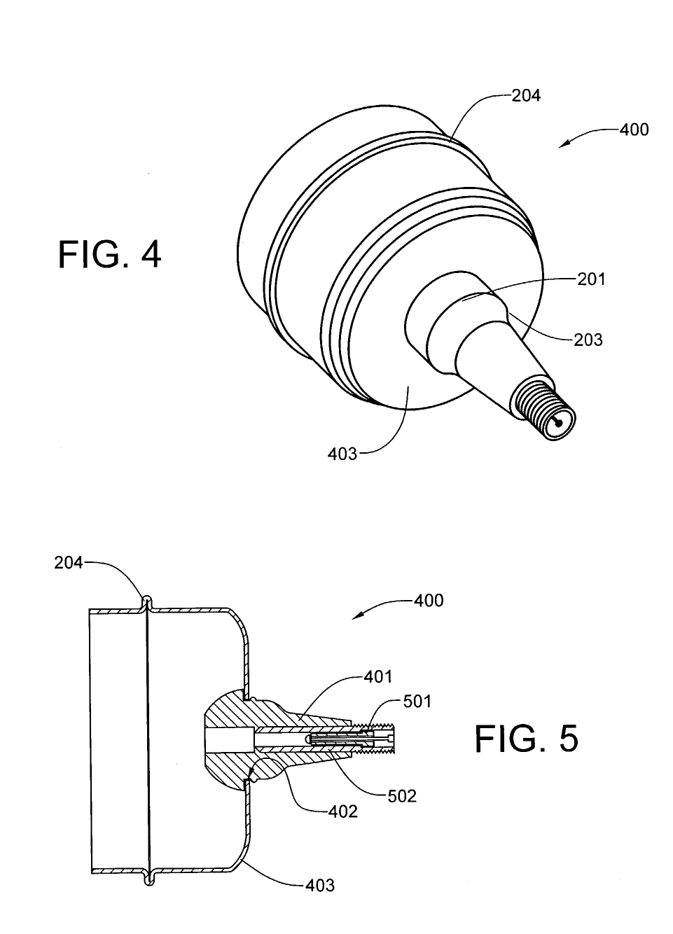

Referring now to FIG. 4, a second embodiment hub cap 400 employs a Schrader-type valve 401 that is inserted through an aperture 402 formed within the hub cap body 403. An annular flange 204 limits the amount that the hub cap 400 may be inserted into the nose of the wheel hub. The use of a Schrader-type valve has several advantages. Firstly, the valves are extremely durable and extremely reliable. Secondly, a number of screw-on pressure-indicating caps are available for these valves. By using a pressure indicating cap in combination with the present invention, the air pressure within the bearing cavity can be readily and visibly monitored without a separate pressure gauge. A disadvantage to the use of a Schrader valve is that it extends outwardly from the hub cap, making it vulnerable to damage if the associated trailer is towed too close to stationary objects.

Referring now to the cross-sectional view os FIG. 5, it will be noted that a Schrader-type valve 401 has a replaceable valve core 501 that screws into the valve stem 502.

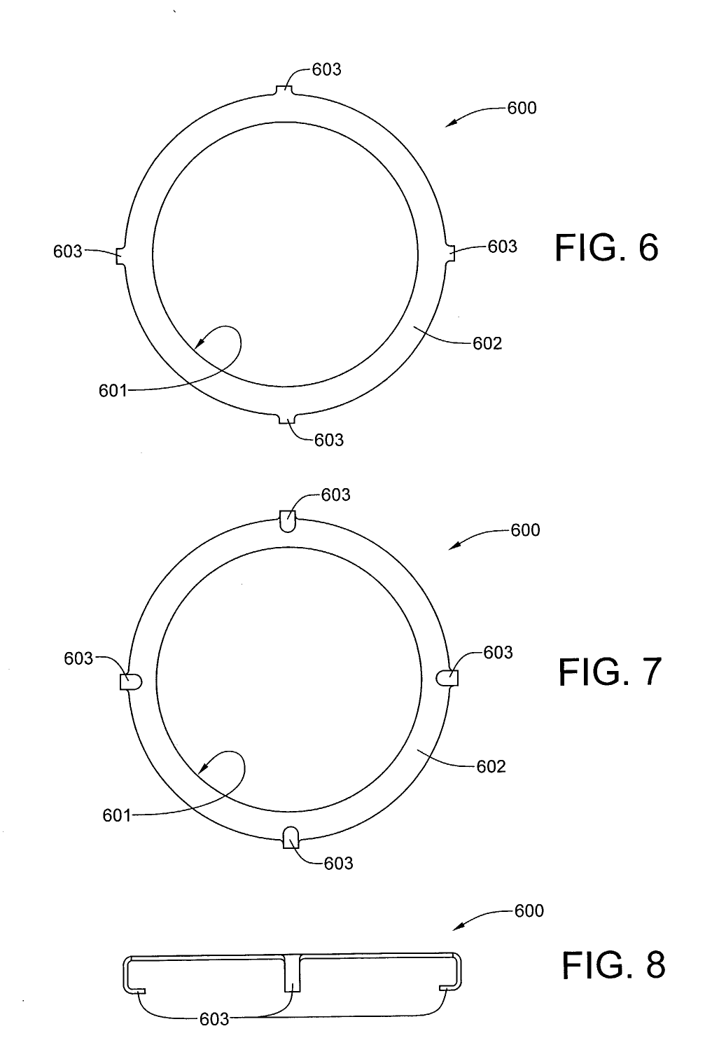

Referring now to FIGS. 6 through 8, a spring retainer clip 600 has a central aperture 601 that is sized to fit over the outer end of a hub cap 200 or 400. The annular flange 204 is larger in diameter than the central aperture 601, thereby acting as a stop for the circular portion 602 of the retaining clip 600. The retainer clip 600 has multiple hooked projections 603 which extend from the circular portion 602, and are oriented toward the wheel hub 101. The nose 110 of the wheel hub 100 can be easily modified to receive each of the hooked projections 603. FIG. 12 shows the modifications required. Spring steel is deemed to be the preferred material from which the retainer clip 600 is fabricated.

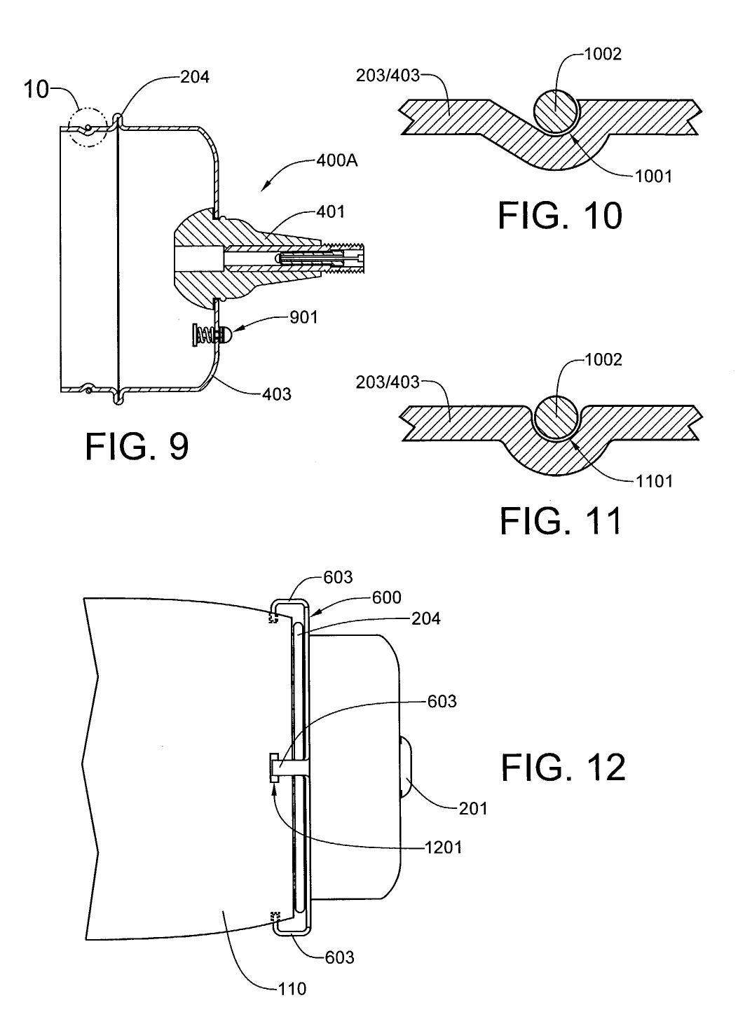

Referring now to FIG. 9, a modified second embodiment valved hub cap 400A includes a pressure release valve 901, that is installed in the hub cap body 403. The pressure release valve limits maximum pressure when the hub cavity is pressurized so that the inner seal will not be damaged by excessive pressure. The maximum allowable pressure, that is determined by the spring constant of a spring incorporated into the pressure release valve 901, is deemed to be about 30 pounds/square inch. The modified second embodiment valved hub cap 400A also includes a circumferential O-ring groove, in which is seated a neoprene rubber O-ring. The O-ring helps to seal the outer opening of the hub cavity 108. The O-ring groove may be designed so that the O-ring also helps prevent the unwanted removal of the hub cap 400A from the hub 100. The portion of FIG. 9 identified as F10 is enlarged in FIG. 10.

Referring now to FIG. 10, enlargement of region F10 of FIG. 9 shows the ramped shape of O-ring groove 1001. When the hub cap body 203/403 in inserted into the nose 110 of the hub 100, the O-ring 1002 is pushed against the right side of the groove 1001. However, when the hub cap body 203/403 is retracted from the nose 110 of the hub 100, the O-ring 1002 rolls up the ramp, wedging itself between the ramped groove 1001 and the inner surface of the nose 110 of the hub body 105. The greater the removal force, the tighter the O-ring is wedged between the two surfaces. It is necessary to destroy the O-ring in order to remove the hub cap.

Referring now to FIG. 11, an enlarged view of a region analogous to region F10 of FIG. 9 shows an O-ring 1002 installed in an O-ring groove 1101 of conventional shape. The hub cap body 203/403 may be installed and removed from the nose 110 of the hub body 105 with about equal force.

Referring now to FIG. 12, a retainer clip 600 is shown installed over a first embodiment valved hub cap 400 and clipped to the nose 110 of a hub body 105. Equiangularly-spaced grooves 1201 have been cut in the nose to receive each of the hooked projections 603. Such grooves may be easily cut using a cut-off wheel mounted on a hand grinder, such as those manufactured and sold by Dremel, Inc. It will be noted that the annular portion 602 of the clip 600 rides the annular flange 204 of the hub cap. It should also be obvious that either a first or second embodiment valved hub cap (200 or 400, respectively) may be so attached to the nose 110 of the hub body 105.

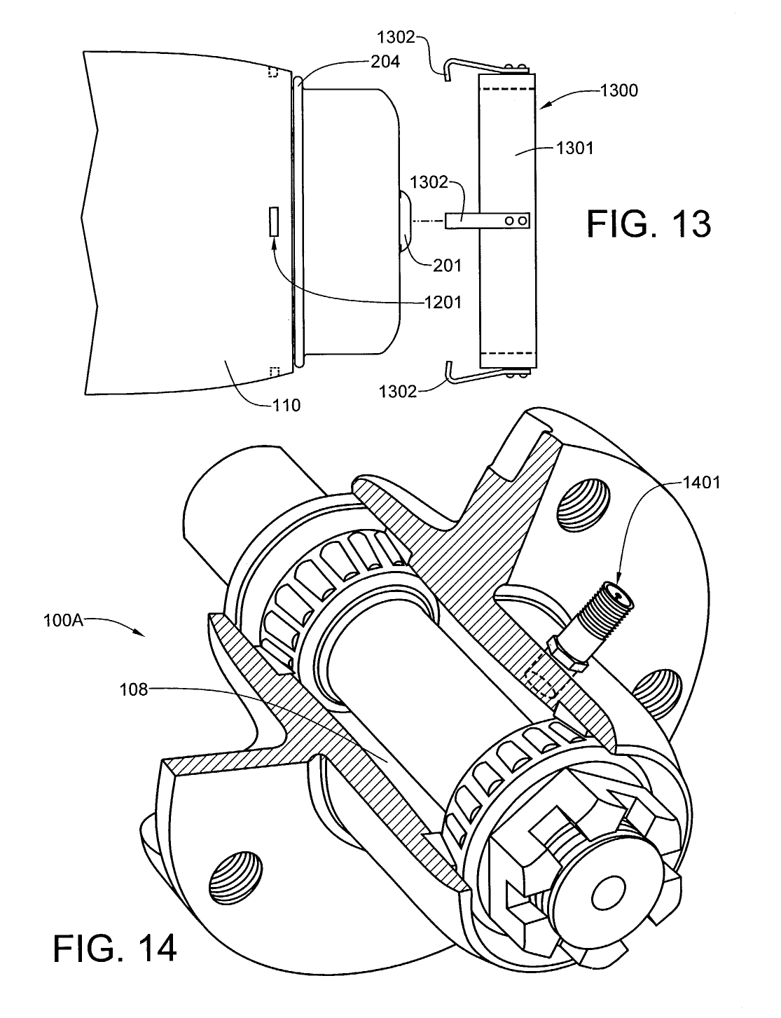

Referring now to FIG. 13, a second embodiment hub cap retaining device 1300 includes an annular member 1301, to which are attached a plurality of spring clips 1302. The device functions in an identical manner to the spring clip 600 of FIGS. 6-8.

Referring now to FIG. 14, a modified conventional hub 100A includes a Schrader valve 1401 that is threadably inserted in a drilled and tapped hole in the hub body 105. Rather than pressurizing the hub cavity 108 through the hub cap, it can be pressurized through the Schrader valve 1401. The Schrader valve 1401 may be removed with a wrench so that the wheel may be removed from the hub.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

What is claimed is:

1. A hub cap for use on boat trailer wheel hubs having a sealed chamber containing a pair of roller bearing assemblies, said hub cap comprising:
a hub cap body that is generally cylindrically-shaped and closed at an outer end thereof, said hub cap body having an aperture therein;
an air valve secured within the aperture, said air valve being readily accessible when the hub cap is installed in a wheel hub, so that air may be pumped into the sealed chamber.

2. The hub cap of claim 1, wherein said aperture is located in the closed outer end of the hub cap body.

3. The hub cap of claim 1, wherein said air valve is a needle valve.

4. The hub cap of claim 1, wherein said air valve is of the Schrader type.

5. The hub cap of claim 1, which further comprises a pressure release valve to limit the maximum amount of air pressure that may be pumped into the sealed chamber.

6. The hub cap of claim 1, which further comprises:
a circumferential O-ring groove in the hub cap body; and
an O-ring installed in the O-ring groove, said O-ring being compressed between the hub cap body and the wheel hub when the hub cap is installed in the wheel hub.

7. The hub cap of claim 6, wherein said O-ring groove is upwardly ramped in a direction away from the closed outer end.

8. The hub cap of claim 1, which further comprises:
an annular flange that limits entry of the hub cap into the wheel hub; and
a retaining device that biases against the annular flange and attaches to the wheel hub with spring clips.

9. A method for pressurizing the sealed chamber of a boat trailer wheel hub, said chamber containing a pair of roller bearing assemblies, the method comprising the steps of:
providing a hub cap that incorporates an air valve therein;
sealing an outer end of the wheel hub with said hub cap;
pumping air into the sealed chamber.

10. The method of claim 9, which further comprises the step of providing an O-ring seal between the hub cap and the wheel hub.

11. The method of claim 9, which further comprises the steps of:
providing a circumferential O-ring groove of ramped cross section in the hub cap; and
providing an O-ring of suitable size for installation in said O-ring groove.

12. The method of claim 9, which further comprises the steps of:
providing an annular flange that limits entry of the hub cap into the wheel hub; and
providing a retaining device that biases against the annular flange and attaches to the wheel hub with spring clips.

13. The method of claim 9, wherein the valve is of the Schrader type.

14. The method of claim 9, wherein the valve is a needle valve.

15. A method for pressurizing the sealed chamber of a boat trailer wheel hub, said chamber containing a pair of roller bearing assemblies, the method comprising the steps of:
drilling a valve installation hole in the wheel hub body;
threading the valve installation hole;
providing an air valve having an externally treaded stem that threadably engages the threaded valve installation hole; and
pumping air into the sealed chamber.

16. The method of claim 15, wherein said valve is of the Schrader type.
